(19) United States
(12) Patent Application Publication
(10) Pub. No.: US 2015/0367536 A1
(43) Pub. Date: Dec. 24, 2015

(54) APPARATUS FOR FORMING ICE SHAPES

(71) Applicant: Clinton Marcus Compton, Frisco, TX (US)

(72) Inventor: Clinton Marcus Compton, Frisco, TX (US)

(21) Appl. No.: 14/311,318

(22) Filed: Jun. 22, 2014

(51) Int. Cl. B29C 33/00

(52) U.S. Cl. CPC B29C 33/0055; B29L 2031/772

(57) ABSTRACT

An apparatus comprises a first mold portion formed from a material having a high thermal conductivity, a first face portion, and a first concave portion. A second mold portion is formed from the material. The second mold portion comprises a second face portion and a second concave portion. Guide pins are in engagement with the first mold portion and the second mold portion for guiding relative movement with the first face portion facing the second face portion, wherein an ice plug disposed between the first concave portion and the second concave portion is partially melted by the relatively high thermal conductivity and the relative movement to mold an ice cube substantially conforming to a shape formed by the first concave portion and the second concave portion. Guide sleeves formed from a substantially hydrophobic material mitigate effects of friction on the guide pins.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to ice-shaping devices. More particularly, the invention relates to device forming desired ice shapes from pieces of ice.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In many situations, people may want to make ice into desired shapes. For example, an ice sphere has less surface area than an ice cube and as a result melts slower when placed in a beverage. However, many current solutions for creating ice spheres and/or other desirable shapes may do so inefficiently and/or create ice pieces having cracks or other imperfections.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. One such aspect of the prior art shows an ice cake maker including a pair of molds formed from a material having a relatively high heat conductivity such as aluminum and guide rods to guide the pair of molds being moved in a predetermined direction By way of educational background, another aspect of the prior art generally useful to be aware of teaches of a multi-purpose ice holding assembly for making and storing of ice. Yet another such aspect of the prior art discloses of a process and equipment for manufacturing clear, solid ice of spherical and other shapes which are capable of making clear ice balls and block ice of other shapes in the mold quickly, efficiently, and with effective energy utilization. However, these solutions may not provide a suitably effective and easy-to-use option for forming ice into desirable shapes. A solution which did so would be desirable.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an exemplary device for shaping ice, in which FIG. 1A is a top 105 portion and FIG. 1B is a bottom 110 portion, in accordance with an embodiment of the present invention;

FIG. 2 is an illustration of an exemplary guide sleeve 200, in which FIG. 2A is an external view and FIG. 2B is an internal view, in accordance with an embodiment of the present invention;

FIG. 3 is an illustration of an exemplary ice plug mold, in accordance with an embodiment of the present invention;

FIG. 4 is an illustration of an exemplary water-catch vessel, in accordance with an embodiment of the present invention;

FIG. 5 is an illustration of an exemplary top 105 portion having a handle, in accordance with an embodiment of the present invention; and

FIG. 6 is an illustration of an exemplary method for forming ice into desirable shapes, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art, many careful considerations and compromises typically must be made when designing for the optimal manufacture of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Some embodiments of the present invention may provide means and/or methods for forming ice into various shapes, including, without limitation, spheres.

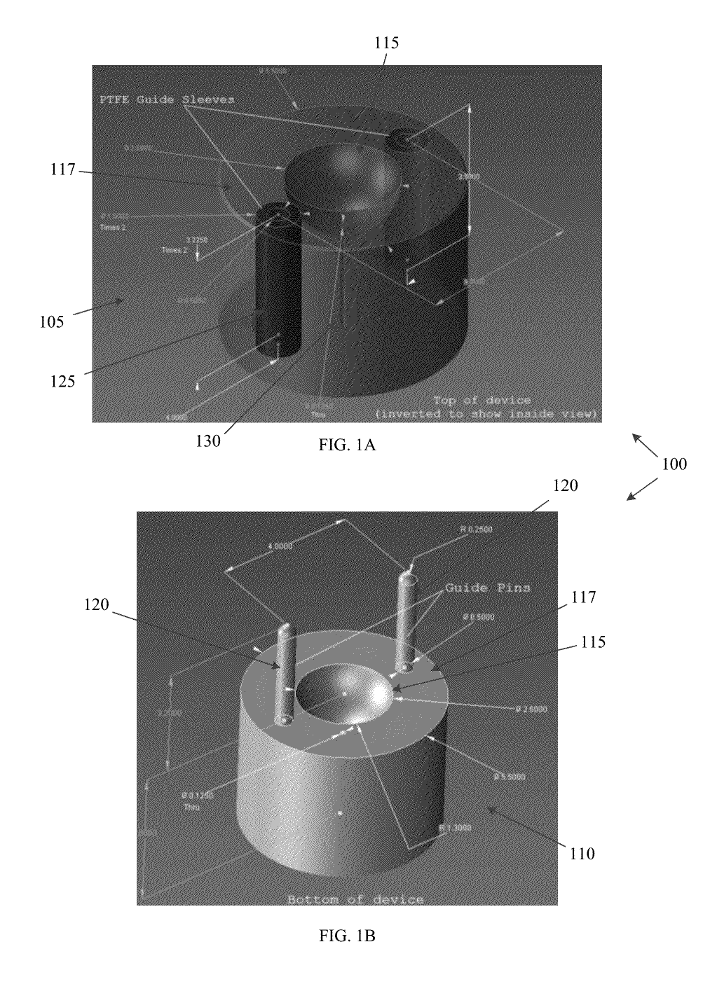

FIG. 1 is an illustration of an exemplary device for shaping ice, in which FIG. 1A is a top 105 portion and FIG. 1B is a bottom 110 portion, in accordance with an embodiment of the present invention. In some embodiments, top 105 portion may be designed to mate with a bottom 110 portion. In the present embodiment, top 105 and/or bottom 110 may have one or more concave portions 115. In some embodiments, concave portions 115 of top 105 and bottom 110 may have reflective symmetry to form uniform hollow areas when top 105 and bottom 110 are joined. In many embodiments, top 105 and bottom 110 may join to form one or more hollow areas of any size and/or shape, including, without limitation, sphere, cube, cylinder, egg, sphere with pointed protrusions, square, trapezoidal, etc. In a non-limiting example, a top 105 and bottom 110 may have hemispheric concave portions 115 having 2.6-inch diameters with depths of 1.3 inches which may join to form a hollow sphere are having a 2.6-inch diameter. In the present embodiment, top 105 and/or bottom may have face portions 117. In some embodiments, face portions 117 may be substantially flat. In some of these embodiment, face portions 117 may have uniform contact when joined. In the present embodiment, bottom 110 may have one or more guide pins 120 which may fit into corresponding receiving areas of top 105 by means of guide sleeves 125. In some embodiments, guide sleeves 125 may be composed of any suitable material, including, without limitation, polytetrafluoroethylene (PTFE) or other substantially hydrophobic material. In the present embodiment, bottom 110 and/or top 105 may have a drain 130 which may allow excess fluid and air to evacuate concave portion 115. In a non-limiting example, drain 130 may have 0.0125-inch, so as to reduce the ice from forming into the holes. Other embodiments may have multiple drains 130 of other diameters.

In some embodiments, top 105 and/or bottom 110 may be composed of one or more materials, including, without limitation, aluminum, copper, magnesium, bronze, steel, and iron. In a non-limiting example, device components may be composed of 6061 anodized aluminum, other 6000 series designations of aluminum, and/or 5xxx, 3xxx, 2xxx, or 7xxx designations. Some currently available products may utilize stainless steel and/or other materials which may exhibit poor thermal conductivity and/or dissipation properties compared to other materials, such as, without limitation, aluminum. In many instances, materials having high thermal conductivity may provide greater thermal dissipation properties which may allow for longer operation time before a device may become too cold to produce ice.

Some embodiments may be suitable for forming ice into desired shapes from other shapes. In a non-limiting example, square and/or irregular-shaped ice cubes may be placed into an embodiment device to form spherical ice cubes.

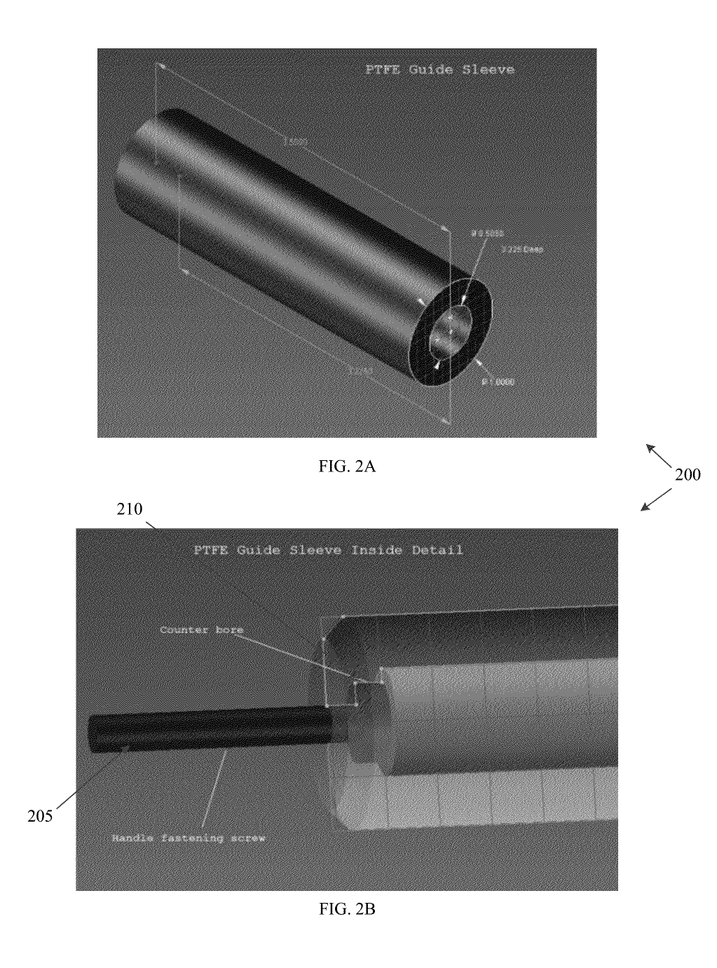

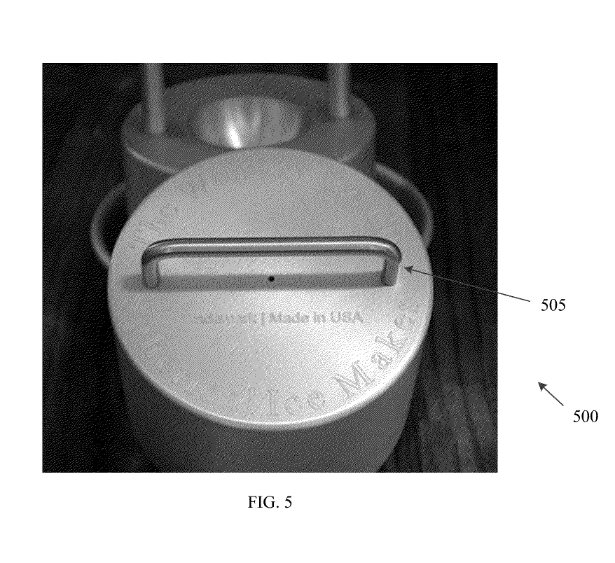

FIG. 2 is an illustration of an exemplary guide sleeve 200, in which FIG. 2A is an external view and FIG. 2B is an internal view, in accordance with an embodiment of the present invention. In some embodiments, guide sleeves 200 may be composed of substantially hydrophobic material, such as, without limitation, Polytetrafluoroethylene (PTFE). In contrast, some currently available products may utilize traditional plastics which may cause cracking and/or increased friction over time. PTFE may demonstrate London dispersion forces due to high electronegativity of its principle component (Fluorine). In addition, PTFE may have a lower friction coefficient than many available solids, which may allow guide sleeves 120 to remain substantially frictionless over an extended period of time. In the present embodiment, guide sleeve 200 may affix to top 105 portion by means of a handle fastening screw 205 and/or a counter bore 210. In many embodiments, fastening screw 205 may be a coated metal screw, typically plated in a material like, but not limited to, zinc, chrome, nickel, or any other plating that reduces corrosion. In other embodiments, the fastening screw may be any type of metal. In many embodiments, counter bore 210 may allow the fastening screw to fit flush inside the guide sleeve. In many embodiments, handle 505, shown in FIG. 5, may be one of any types of metal that has reduced corrosion properties. In some embodiments, handle 505 may be, without limitation, chrome plated, nickel plated, anodized aluminum, powder coated steel, etc.

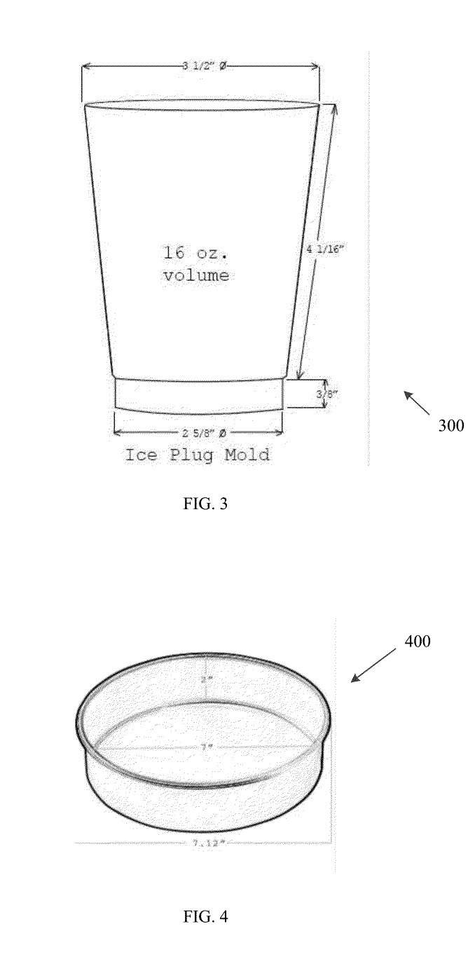

FIG. 3 is an illustration of an exemplary ice plug mold, in accordance with an embodiment of the present invention. In the present embodiment, an ice plug mold 300 may be suitable for freezing water to form an ice plug. In some embodiments, ice plug mold may have any suitable shape, including, without limitation, semi-conical. In contrast, some available solutions may utilize molds have octagonal sides. In many instances, ice plugs having smooth, rounded sides may fit more effectively into a spherical concave portion 115. Such ice plugs may also be more stable during melting and may more effectively produce desired ice shapes. In many embodiments, ice plugs may be easily removed from ice plug molds 300 due to smooth sides of both ice plugs and ice plug molds 300. In some alternative embodiments, ice plug mold 300 may be attached to other components of device. In a non-limiting example, ice plug mold 300 may be attached to bottom 110 to provide a simple transition for moving ice from ice plug mold 300 to concave portion 115.

FIG. 4 is an illustration of an exemplary water-catch vessel, in accordance with an embodiment of the present invention. In some embodiments, vessel 400 may be suitable for receiving liquid from drain 130. In the present embodiment, vessel 400 may have suitable depth and width to allow for repeated use of ice-shaping device. In some alternative embodiments, vessel 400 may be connected to bottom of bottom 110 portion. In some embodiments, vessel 400 may be affixed to the bottom of the device such as, but not limited to, by welding, soldering or gluing with a waterproof adhesive. In some embodiment, bottom 110 may be raised slightly, by any amount, to allow for water drainage from the drain 130. In many embodiments, vessel 400 may be removable/separate.

FIG. 5 is an illustration of an exemplary top 105 portion having a handle, in accordance with an embodiment of the present invention. In the present embodiment, a top 105 portion may have a handle 505 to assist users in moving top 105 and/or pulling top 105 off of bottom 110 following shaping of ice. In some embodiments, handle 505 may be flat. Other embodiments may utilize any kind of handle 505, including, without limitation, knob, round handle, etc.

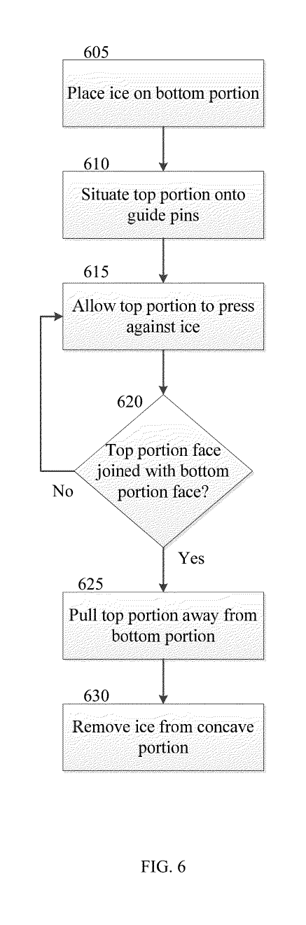

FIG. 6 is an illustration of an exemplary method for forming ice into desirable shapes, in accordance with an embodiment of the present invention. In the present embodiment, a user may place a piece of ice onto a bottom 110 portion in a step 605. In a non-limiting example, a user may place a piece of ice such as, but not limited to, an ice plug from ice plug mold 300 into a concave portion 115 of bottom 110. In the present non-limiting example, the ice plug shape has a top of a semi-cone shape that is slightly smaller in diameter than concave portion 115 with a bottom that is larger than that of the diameter of concave portion 115. In other embodiments, a square shape or other larger ice shape may also be used with less effectiveness. In the present embodiment, user may situate top 105 onto guide pins 120 of bottom 110 in a step 610. Further, in the present embodiment, user may allow top 105 to press against ice in a step 615. The user may not be required to press down on the device to make it work, the weight of the device and the thermo dynamic property of the metal (aluminum) do the work. In some embodiments, weight and/or thermo-electric action of top 105 and/or ambient heat may cause edges of ice to melt. In the present embodiment, user may determine whether face portions 117 of top 105 and bottom 110 have made contact in a step 620. Further, in the present embodiment, if face portions 117 have made contact, user may pull top 105 away from bottom 110 in a step 625. In some embodiments, user may pull top 105 off of guide pins 120. In some alternative embodiments, top 105 and/or guide pins 120 may have locking functionality to allow top 105 to improve efficiency between uses. In a non-limiting example, guide pins 120 may have notches cut into them and top 105 may have catches which user may control to allow top 105 to rest in notches or continue moving along guide pins 120. In the present embodiment, user may remove ice from concave portion 115 of bottom 110 in a step 630. In some embodiments, user may use tongs or other suitable tool to remove ice.

Many embodiments of the present may be suitable for forming ice into desirable shapes without a process of freezing a liquid into the desirable shapes, a process which may often result in excessive cracking of formed ice due to the expansion behavior of ice. Some available solutions may produce ice which may be unsuitably large for many drinking containers. In contrast, many embodiments of the present invention may be suitable for producing ice pieces which may be suitable for many drinking containers. In a non-limiting example, an embodiment device may produce ice spheres having 2.6-inch diameters which may allow for a “normal pour” of 1.5 to 2.5 ounces of liquid while ice may be present in a drinking container.

Some embodiments of the present invention may be suitable for producing ice spheres, which may have less surface area than other ice shapes and may, as a result, melt slower when placed in a beverage.

One or more embodiments may utilize an ambient heating source to keep device components warm. In some of these embodiments, heating source may be waterproof.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3rd parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing ice-shaping devices according to the present invention will be apparent to those skilled in the art. Various aspects of the invention have been described above by way of illustration, and the specific embodiments disclosed are not intended to limit the invention to the particular forms disclosed. The particular implementation of the ice-shaping devices may vary depending upon the particular context or application. By way of example, and not limitation, the ice-shaping devices described in the foregoing were principally directed to ice sphere implementations; however, similar techniques may instead be applied to any ice shapes, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a first mold portion formed from a material having a relatively high thermal conductivity, said first mold portion comprising a first face portion, said first face portion comprising a first concave portion being disposed therein;
a second mold portion formed from said material, said second mold portion comprising a second face portion, said second face portion comprising a second concave portion being disposed therein;
one or more guide pins being in engagement with said first mold portion and said second mold portion, said one or more guide pins being operable for guiding relative movement of said first mold portion and said second mold portion with said first face portion facing said second face portion, wherein an ice plug disposed between said first concave portion and said second concave portion is partially melted by said relatively high thermal conductivity and said relative movement to mold an ice cube substantially conforming to a shape formed by said first concave portion and said second concave portion; and
one or more guide sleeves formed from a substantially hydrophobic material, said one or more guide sleeves being in engagement with said one or more guide pins during said relative movement for mitigating effects of friction.

2. The apparatus as recited in claim 1, in which said hydrophobic material comprises polytetrafluoroethylene.

3. The apparatus as recited in claim 1, in which said first mold portion further comprises receiving areas in which said one or more guide sleeves are disposed.

4. The apparatus as recited in claim 1, further comprising a handle in engagement with said first mold portion for grasping during movement of said first mold portion.

5. The apparatus as recited in claim 4, further comprising means for joining said handle to said first mold portion.

6. The apparatus as recited in claim 1, in which said first mold portion further comprises at least one drain for evacuation of air and fluid from said first concave portion

7. The apparatus as recited in claim 1, further comprising a vessel for retaining excess fluid.

8. The apparatus as recited in claim 1, in which said first concave portion and said second concave portion each comprise a hemispherical shape to form a spherical ice cube.

9. The apparatus as recited in claim 1, in which said material comprises anodized aluminum.

10. An apparatus comprising:
means for forming a first mold portion;
means for forming a second mold portion;
means for guiding relative movement of said means for forming a first mold portion and said means for forming a second mold portion, wherein an ice plug disposed between said means for forming a first mold portion and said means for forming a second mold portion is partially melted to mold an ice cube substantially conforming to a shape formed by said means for forming a first mold portion and said means for forming a second mold portion; and
means for mitigating effects of friction on said guiding means.

11. The apparatus as recited in claim 10, further comprising means for grasping during movement of said means for forming a first mold portion.

12. The apparatus as recited in claim 11, further comprising means for joining said grasping means to said means for forming a first mold portion.

13. The apparatus as recited in claim 10, further comprising means for retaining excess fluid.

14. A system comprising:
a first mold portion formed from a material having a relatively high thermal conductivity, said first mold portion comprising a first face portion, said first face portion comprising a first concave portion being disposed therein, said first concave portion comprising a hemispherical shape;
a second mold portion formed from said material, said second mold portion comprising a second face portion, said second face portion comprising a second concave portion being disposed therein, said second concave portion comprising said hemispherical shape;
ice plug mold being configured for forming an ice plug during a freezing process of water, said ice plug comprising a semi-conical shape having a top that is smaller in diameter than a diameter of said hemispherical shape with a bottom that is larger than said diameter of said hemispherical shape;
one or more guide pins being in engagement with said first mold portion and said second mold portion, said one or more guide pins being operable for guiding relative movement of said first mold portion and said second mold portion with said first face portion facing said second face portion, wherein said ice plug disposed between said first concave portion and said second concave portion is partially melted by said relatively high thermal conductivity and said relative movement to mold an ice cube substantially conforming to a spherical shape; and
one or more guide sleeves formed from a substantially hydrophobic material, said one or more guide sleeves being in engagement with said one or more guide pins during said relative movement for mitigating effects of friction; and
a vessel for retaining excess water from said melting.

15. The system as recited in claim 14, in which said hydrophobic material comprises polytetrafluoroethylene.

16. The system as recited in claim 14, in which said first mold portion further comprises receiving areas in which said one or more guide sleeves are disposed.

17. The system as recited in claim 14, further comprising a handle in engagement with said first mold portion for grasping during movement of said first mold portion.

18. The system as recited in claim 17, further comprising means for joining said handle to said first mold portion.

19. The system as recited in claim 14, in which said first mold portion further comprises at least one drain for evacuation of air and fluid from said first concave portion

20. The system as recited in claim 14, in which said material comprises anodized aluminum.
